(19) United States
(12) Patent Application Publication
(10) Pub. No.: US 2024/0154664 A1
(43) Pub. Date: May 9, 2024

(54) CONFIGURING SHARED AND UE SPECIFIC BEAMS AND TCI STATES

(71) Applicant: Lenovo (Singapore) Pte. Ltd., New Tech Park (SG)

(72) Inventors: Ankit Bhamri, Rödermark (DE); Ali Ramadan Ali, Kraiburg am Inn (DE); Karthikeyan Ganesan, Kronberg im Taunus (DE); Robin Thomas, Bad Nauheim (DE)

(21) Appl. No.: 18/550,080

(22) PCT Filed: Mar. 8, 2022
(86) PCT No.: PCT/IB2022/052056

§ 371 Date: Sep. 11, 2023

Related U.S. Application Data
(60) Provisional application No. 63/159,906, filed on Mar. 11, 2021.

(51) Int. Cl. H04B 7/06; H04L 5/00; H04W 72/23

(52) U.S. Cl. CPC H04B 7/0617; H04L 5/0053; H04W 72/23

(57) ABSTRACT

Apparatuses, methods, and systems are disclosed for configuring shared and UE specific beams and TCI states. One method includes receiving, at a user equipment (UE) from a network device, configuration information for shared UE beams, shared transmission configuration indicator (TCI) states, UE-specific beams, and/or UE-specific TCI states. The method includes receiving, from the network device, a medium access control (MAC) control element (CE) that activates a subset of the shared UE beams, the shared TCI states, the UE-specific beams, and/or the UE-specific TCI states. The method includes receiving, from the network device, downlink control information (DCI) for indicating at least one beam, and/or at least one TCI state from the activated subset of the shared UE beams, the shared TCI states, the UE-specific beams, and/or the UE-specific TCI states.

### CROSS-REFERENCE TO RELATED APPLICATIONS

This application claims priority to U.S. Patent Application Ser. No. 63/159,906 entitled “APPARATUSES, METHODS, AND SYSTEMS FOR CONFIGURATION AND SWITCHING BETWEEN DIFFERENT BEAM/TCI MODES” and filed on Mar. 11, 2021 for Ankit Bhamri, which is incorporated herein by reference in its entirety.

### FIELD

The subject matter disclosed herein relates generally to wireless communications and more particularly relates to configuring shared and UE specific beams and TCI states.

### BACKGROUND

In certain wireless communications networks, shared and/or common beams may be used. In such networks, a device may switch between a UE specific beam and a shared beam.

### BRIEF SUMMARY

Methods for configuring shared and UE specific beams and TCI states are disclosed. Apparatuses and systems also perform the functions of the methods. One embodiment of a method includes receiving, at a user equipment (UE) from a network device, configuration information for shared UE beams, shared transmission configuration indicator (TCI) states, UE-specific beams, UE-specific TCI states, or some combination thereof. In some embodiments, the method includes receiving, from the network device, a medium access control (MAC) control element (CE) that activates a subset of the shared UE beams, the shared TCI states, the UE-specific beams, the UE-specific TCI states, or some combination thereof. In certain embodiments, the method includes receiving, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

One apparatus for configuring shared and UE specific beams and TCI states includes a user equipment. In some embodiments, the apparatus includes a receiver that: receives, from a network device, configuration information for shared UE beams, shared transmission configuration indicator (TCI) states, UE-specific beams, UE-specific TCI states, or some combination thereof; receives, from the network device, a medium access control (MAC) control element (CE) that activates a subset of the shared UE beams, the shared TCI states, the UE-specific beams, the UE-specific TCI states, or some combination thereof, and receives, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

Another embodiment of a method for configuring shared and UE specific beams and TCI states includes transmitting, from a network device to a user equipment (UE), configuration information for shared UE beams, shared transmission configuration indicator (TCI) states, UE-specific beams, UE-specific TCI states, or some combination thereof. In some embodiments, the method includes transmitting, to the UE, a medium access control (MAC) control element (CE) that activates a subset of the shared UE beams, the shared TCI states, the UE-specific beams, the UE-specific TCI states, or some combination thereof. In certain embodiments, the method includes transmitting, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

Another apparatus for configuring shared and UE specific beams and TCI states includes a network device. In some embodiments, the apparatus includes a transmitter that: transmits, to a user equipment (UE), configuration information for shared UE beams, shared transmission configuration indicator (TCI) states, UE-specific beams, UE-specific TCI states, or some combination thereof; transmits, to the UE, a medium access control (MAC) control element (CE) that activates a subset of the shared UE beams, the shared TCI states, the UE-specific beams, the UE-specific TCI states, or some combination thereof, and transmits, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring shared and UE specific beams and TCI states;

FIG. 2 is a schematic block diagram illustrating one embodiment of an apparatus that may be used for configuring shared and UE specific beams and TCI states;

FIG. 3 is a schematic block diagram illustrating one embodiment of an apparatus that may be used for configuring shared and UE specific beams and TCI states;

FIG. 4 is a diagram illustrating one embodiment of a structure of a shared-TCI-state information element;

FIG. 5 is a flow chart diagram illustrating one embodiment of a method for configuring shared and UE specific beams and TCI states; and

FIG. 6 is a flow chart diagram illustrating another embodiment of a method for configuring shared and UE specific beams and TCI states.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

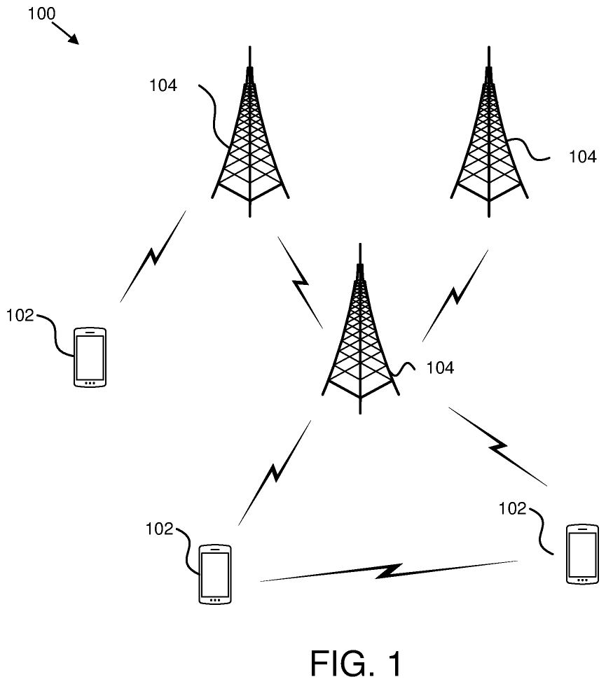

FIG. 1 depicts an embodiment of a wireless communication system 100 for configuring shared and UE specific beams and TCI states. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a user equipment (UE) from a network device, configuration information for shared UE beams, shared transmission configuration indicator (TCI) states, UE-specific beams, UE-specific TCI states, or some combination thereof. In some embodiments, the remote unit 102 may receive, from the network device, a medium access control (MAC) control element (CE) that activates a subset of the shared UE beams, the shared TCI states, the UE-specific beams, the UE-specific TCI states, or some combination thereof. In certain embodiments, the remote unit 102 may receive, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof. Accordingly, the remote unit 102 may be used for configuring shared and UE specific beams and TCI states.

In certain embodiments, a network unit 104 may transmit, from a network device to a user equipment (UE), configuration information for shared UE beams, shared transmission configuration indicator (TCI) states, UE-specific beams, UE-specific TCI states, or some combination thereof. In some embodiments, the network unit 104 may transmit, to the UE, a medium access control (MAC) control element (CE) that activates a subset of the shared UE beams, the shared TCI states, the UE-specific beams, the UE-specific TCI states, or some combination thereof. In certain embodiments, the network unit 104 may transmit, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof. Accordingly, the network unit 104 may be used for configuring shared and UE specific beams and TCI states.

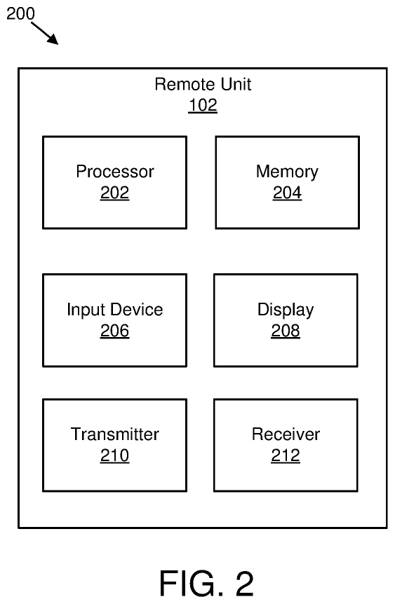

FIG. 2 depicts one embodiment of an apparatus 200 that may be used for configuring shared and UE specific beams and TCI states. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives, from a network device, configuration information for shared UE beams, shared transmission configuration indicator (TCI) states, UE-specific beams, UE-specific TCI states, or some combination thereof; receives, from the network device, a medium access control (MAC) control element (CE) that activates a subset of the shared UE beams, the shared TCI states, the UE-specific beams, the UE-specific TCI states, or some combination thereof, and receives, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

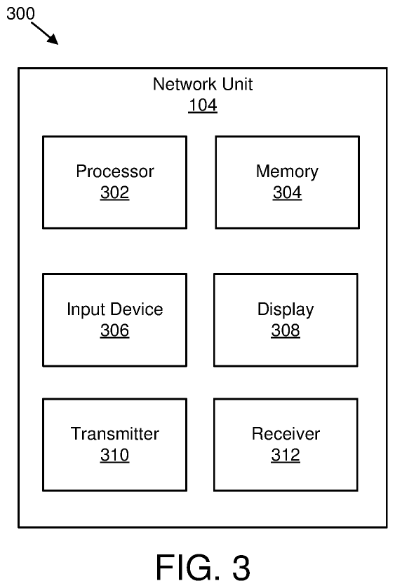

FIG. 3 depicts one embodiment of an apparatus 300 that may be used for configuring shared and UE specific beams and TCI states. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310: transmits, to a user equipment (UE), configuration information for shared UE beams, shared transmission configuration indicator (TCI) states, UE-specific beams, UE-specific TCI states, or some combination thereof, transmits, to the UE, a medium access control (MAC) control element (CE) that activates a subset of the shared UE beams, the shared TCI states, the UE-specific beams, the UE-specific TCI states, or some combination thereof, and transmits, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

It should be noted that one or more embodiments described herein may be combined into a single embodiment.

In certain embodiments, such as in new radio (“NR”), beam-management framework is enhanced to include the possibility to indicate uplink (“UL”) beams via a transmission configuration indicator (“TCI”) state indication. In some embodiments, a beam indication may be enhanced as a separate TCI indication for UL and downlink (“DL”), a joint TCI indication may be used for UL and DL, only an UL TCI indication may be used, and/or only a DL TCI indication may be used. In various embodiments, it may be indicated how a UE determines which one of the TCI indication modes it needs to follow to identify a suitable DL receive (“RX”) beam and an UL transmit (“TX”) beam. Furthermore, in certain embodiments, if a UE is capable of a shared and/or common beam framework, then it may be determined how to configure and/or switch between user equipment (“UE”) specific beam and/or TCI indication and shared UE beams and/or TCI also.

In some embodiments, it may be determined how and when to configure and/or switch between different modes of TCI state signaling for UE-specific TCI and/or beams, and/or how and when to configure and/or switch between UE-specific beam and/or TCI mode and shared UE beam and/or TCI modes. In various embodiments, it may be determined if indicated beams and/or TCIs from a network to UEs belong to one or following of the categories, subcategories, and/or modes for a beam framework: 1) category 1: UE-specific TCI and/or beam (“TCI/beam”) indication, a) category (“Cat”) 1-1: a TCI/beam indication for only a physical downlink shared channel (“PDSCH”), b) Cat 1-2: a TCI/beam indication for a PDSCH and physical downlink control channel (“PDCCH”) control resource sets (“CORESETs”), c) Cat 1-3: a TCI/beam indication for only a physical uplink shared channel (“PUSCH”), d) Cat 1-4: a TCI/beam indication for a PUSCH and a physical uplink control channel (“PUCCH”), e) Cat 1-5: a TCI/beam indication for a PDSCH and a PUSCH, f) Cat 1-6: a TCI/beam indication for a PDSCH, PDCCH CORESETs and a PUSCH, g) Cat 1-7: a TCI/beam indication for a PDSCH, a PUSCH, and a PUCCH, and/or h) Cat 1-8: a TCI/beam indication for a PDSCH, PDCCH CORESETs, a PUSCH, and a PUCCH; and/or 2) category 2: shared UE TCI/beam indication, a) Cat 2-1: a shared UE beam indication for only a PDSCH, b) Cat 2-2: a shared beam indication for a PDSCH and PDCCH CORESETs, c) Cat 2-3: a shared beam indication for only a PUSCH, d) Cat 2-4: a shared beam indication for a PUSCH and a PUCCH, e) Cat 2-5: a shared beam indication for a PDSCH and a PUSCH, f) Cat 2-6: a shared beam indication for a PDSCH, PDCCH CORESETs, and a PUSCH, g) Cat 2-7: a shared beam indication for a PDSCH, a PUSCH, and a PUCCH, and/or h) Cat 2-8: a shared beam indication for a PDSCH, PDCCH CORESETs, a PUSCH, and a PUCCH.

In various embodiments, there may be a fallback mechanism for beam-management related procedures from a shared beam framework to a UE-specific beam framework is also. It should be noted that the shared beam framework can imply zone, region, position, and/or transmission and reception point (“TRP”) based shared beams across multiple UEs.

Certain embodiments described herein may facilitate switching and/or configuration between a shared beam framework and a UE-specific beam framework to be able to dynamically adapt procedures depending upon instantaneous changes in an environment (e.g., that could lead to beam blockage, beam failure, and so forth) and have the possibility to fallback to a default mode. Also, such embodiments can use both frameworks as being complimentary to each other. In some embodiments, any ambiguity may be removed in terms of applicability of an indicated beam to which channel and/or uplink/downlink direction the beam is applied.

In a first set of embodiments, there may be configuring and/or switching between UE-specific beams and shared UE beams. In the first embodiment set, there may be signaling and procedure details to configure a UE with UE-specific beams, shared UE beams, or a combination of such beams. Based on the configuration, the UE determines if the indicated beams are UE-specific or shared UE beams.

In a first embodiment of the first set of embodiments, there may be a separate TCI pool configuration for shared UE beams and UE-specific beams with separate medium access control (“MAC”) control element (“CE”) activation and/or deactivation. In the first embodiment of the first set of embodiments, the UE is semi-statically configured by a radio resource control (“RRC”) configuration with two set of TCI states. The first set includes a pool of UE-specific TCI states and the second set includes a pool of shared UE TCI states. The RRC configuration of the shared UE TCI states can be a common RRC configuration across multiple UEs.

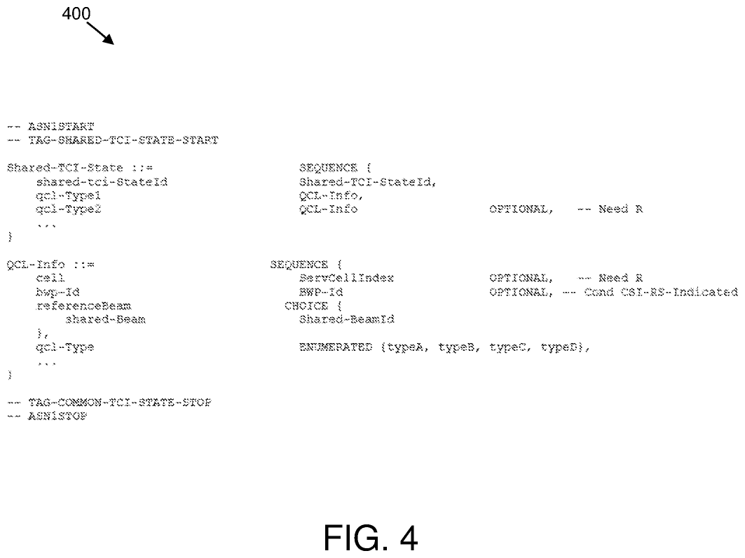

FIG. 4 is a diagram illustrating one embodiment of a structure of a shared-TCI-state information element (“IE”) 400.

In the first embodiment of the first set of embodiments, in addition to an IE with a TCI state in an RRC configuration, another IE with a shared TCI state is added to the RRC configuration that can be commonly configured across a group of UEs. Each shared TCI state can include up to N quasi-co-location (“QCL”) types, and at least one QCL type indicates a spatial relation for a target beam. One key difference between the shared TCI state and a TCI state is that the source reference signal (“RS”) (e.g., beam) can only be a shared RS (e.g., beam) that is shared across a group of UEs instead of a UE-specific RS (e.g., beam). All the QCL types such as typeA, typeB, typeC and typeD can be similarly configured, but with a source RS (e.g., beam) as a shared RS (e.g., beam).

In one implementation of the first embodiment of the first set of embodiments, a sub-set of shared TCI states configured by RRC is activated by a new shared TCI state activation and/or deactivation MAC CE that is different from a (e.g., UE-specific) TCI state activation (or deactivation) UE-specific PDSCH, PDCCH, PUSCH, and/or PUCCH MAC CE. In addition, the UE-specific TCI states can also be activated (or deactivated) by UE-specific PDSCH, PDCCH CORESETs, PUSCH, and/or PUCCH MAC CE. In another implementation of the first embodiment of the first set of embodiments, a group common MAC CE is used to indicate the activation and/or deactivation of shared UE TCI states for PDSCH, PUSCH, PDCCH CORESETs, PUCCH, or some combination thereof. In some embodiments, ControlResourceSet information element is enhanced with a field to indicate shared-tci-PresentInDCI, wherein if this field is enabled, the TCI codepoint in the DCI indicates shared beams if the UE is activated with both UE-specific TCI states and shared UE TCI states. Furthermore, if shared-tci-PresentInDCI is enabled, then the UE is not expected to be enabled with tci-PresentInDCI. In various embodiments, both shared-tci-PresentInDCI and tci-PresentInDCI can be enabled in a ControlResourceSet IE; however, the downlink control information (“DCI”) can indicate only shared TCI or UE-specific TCI, where the UE can be implicitly and/or explicitly indicated in the DCI about whether to use shared TCI or UE-specific TCI states (e.g., from the sub-set activated by MAC CE).

In other implementation of the first embodiment of the first set of embodiments, either a sub-set of the shared TCI states configured by RRC is activated by MAC CE or a sub-set of the UE-specific TCI states configured by RRC is activated by MAC CE, but both cannot be activated at the same time by MAC CE. However, once the already activate sub-set is deactivated, then the alternate sub-set could be activated. Based on the activated group, tci-PresentInDCI can be used to indicate if DCI has the codepoint to indicate one or more of the activated TCI states (e.g., that could be either shared TCI or UE-specific TCI depending up on which group is activated by the MAC CE). Specifically, only a single field in DCI is needed for such a TCI indication.

In certain embodiments, only a single pool of TCI states can be configured by RRC between UE-specific TCI states and shared UE TCI states. In such embodiments, the same MAC CE activation, TCI enabling field for DCI in a CORESET configuration, and TCI indication in DCI can be used to indicate UE-specific TCI or shared UE TCI depending upon which one of the two pools is configured by a network.

In some embodiments, if both UE-specific TCI states and shared TCI states are configured by a network, then a combination of both shared TCI states and UE-specific TCI states can be activated and indicated for different channels of the same UE. In one example, a UE can be configured with a shared TCI state for PDCCH reception, while a UE-specific TCI state can be indicated for PDSCH reception. All combinations of shared and UE-specific TCI states across both UL and DL channels and/or signals can be possible to be indicated to a UE at the same time slot or in a different time slot. In one implementation, each of the CORESETs is configured with a shared TCI state and UE specific TCI states and, in another implementation, each of the DL and UL physical channels could be separately configured with a shared TCI state and UE specific TCI states. In one example, a UE could receive using a shared TCI and transmit using a UE specific TCI state.

In various embodiments, shared TCI with only QCL typeD is expected to be configured, activated, and/or indicated to a UE, while other QCL types such as typeA, typeB, and typeC are valid only with a UE-specific TCI. Other combinations are also possible and some QCL types can be shared TCI, some QCL types can be UE-specific, and some QCL types can be applicable with both.

In certain embodiments, each of a configured grant (“CG”) type 1 and CG type 2 resource could be separately configured with a shared TCI state and UE specific TCI states. In such embodiments, a UE autonomously switches a TCI state to receive from a respective CG configuration.

In some embodiments, each of a TRP or a group of TRPs could be configured separately to receive and/or transmit using shared TCI or UE specific TCI.

It should be noted that embodiments and/or implementations herein may be applied for: 1) semi-persistent scheduling (“SPS”) PDSCH; 2) CG PUSCH; and/or 3) other DL and/or UL (“DL/UL”) signals such as channel state information reference signal (“CSI-RS”), synchronization signal block (“SSB”), sounding reference signal (“SRS”), and/or phase tracking reference signal (“PT-RS”).

In a second embodiment of the first set of embodiments, there may be a separate TCI pool configuration for shared UE beams and UE-specific beams with single MAC CE activation and/or deactivation. According to the second embodiment of the first set of embodiments, a UE is semi-statically configured by an RRC configuration with two set of TCI states. The first set includes a pool of UE-specific TCI states and the second set includes a pool of shared UE TCI states. The RRC configuration for shared UE TCI states can be a RRC configuration (e.g., same and/or similar semi-static configuration across multiple UEs). However, in this embodiments, only single MAC CE activation (or deactivation) is used to activate (or deactivate) a sub-set of TCI states, wherein some of the TCI states in the activated sub-set of TCI states are shared TCI states and some of the other TCI states are UE-specific TCI states.

In one implementation, for a TCI state ID (e.g., one index), only a UE-specific TCI state can be indicated or a shared TCI state can be indicated, but both shared and UE-specific TCI states cannot be activated and/or indicated with a single TCI state ID. The UE is able to identify whether the TCI state is shared or UE-specific depending up on the source RS (or beam), wherein a shared TCI state can only have a common RS ID (or beam ID) and a UE-specific TCI state can only have a UE-specific RS ID (e.g., beam ID) and/or SSB ID. Regardless of which TCI states are activated, the same MAC CE and the same PDCCH and/or DCI signaling can be applied to indicate a UE-specific and/or a shared UE TCI state.

In another implementation, for a TCI state ID (e.g., one index), both a UE-specific TCI state and a shared TCI state can be indicated. The UE is able to identify whether the TCI state is shared or UE-specific depending on the source RS (or beam), wherein the shared TCI state can only have a common RS ID (or beam ID) and the UE-specific TCI state can only have a UE-specific RS ID (or beam ID) and/or SSB ID. Regardless of which TCI states are activated, a same MAC CE and a same PDCCH and/or DCI signaling can be applied to indicate a UE-specific and/or a shared UE TCI state. For example, a single TCI state ID indicates two TCI states, wherein the first TCI state indicates a UE-specific TCI state and a second TCI state indicates a shared TCI state, or vice-versa.

In a third embodiment of the first set of embodiments, a single TCI pool configuration for shared UE beams and UE-specific beams with a single MAC CE activation and/or deactivation. According to the third embodiment of the first set of embodiments, a UE is semi-statically configured by RRC configuration with only a single set of TCI states, wherein some TCI state IDs within the set can be UE-specific TCI states while some other TCI state IDs can be shared TCI states. In this embodiment, only a single MAC CE activation (or deactivation) is used to activate (or deactivate) a sub-set of TCI states, wherein some of the TCI states in the activated sub-set of TCI states are shared TCI states and some of the other TCI states are UE-specific TCI states.

In one implementation, for a TCI state ID (e.g., one index), only a UE-specific TCI state can be indicated or a shared TCI state can be indicated, but both shared and UE-specific TCI states cannot be activated and/or indicated with a single TCI state ID. The UE is able to identify whether the TCI state is shared or UE-specific depending on a source RS (or beam), wherein the shared TCI state can only have a common RS ID (or beam ID) and a UE-specific TCI state can only have a UE-specific RS ID (or beam ID) and/or SSB ID. Regardless of which TCI states are activated, the same MAC CE and the same PDCCH and/or DCI signaling can be applied to indicate the UE-specific and/or the shared UE TCI state.

In another implementation, for a TCI state ID (e.g., one index), both a UE-specific TCI state and a shared TCI state can be indicated. The UE is able to identify whether the TCI state is shared or UE-specific depending on a source RS (or beam), wherein the shared TCI state can only have a common RS ID (or beam ID) and the UE-specific TCI state can only have a UE-specific RS ID (or beam ID) and/or SSB ID. Regardless of which TCI states are activated, the same MAC CE and the same PDCCH and/or DCI signaling can be applied to indicate the UE-specific and/or the shared UE TCI state. For example, a single TCI state ID indicates two TCI states, wherein the first TCI state indicates the UE-specific TCI state and the second TCI state indicates the shared TCI state, or vice-versa.

In a second set of embodiments, there may be configuring and/or switching between a TCI indication for different channels of a UE. In the second set of embodiments, signaling methods and procedures to determine which TCI and/or beam indication mode is applied at the UE among: 1) different modes for UE-specific TCI and/or beam indication for DL and UL (e.g., among category 1 options if UE-specific TCI signaling is configured and/or indicated according to the first set of embodiments; and/or 2) different modes for shared UE TCI and/or beam indication for DL and UL (e.g., among category 2 options if shared UE TCI signaling is configured and/or indicated according to the first set of embodiment.

According to the second set of embodiments, the UE is semi-statically configured by RRC configuration with two set of TCI states, wherein the first set includes a pool of DL TCI states and the second set includes a pool of UL TCI states. In such embodiments, in addition to a TCI state IE in RRC configuration, another IE such as an UL TCI state IE is indicated in an RRC configuration for configuring a pool of UL TCI states.

In a first embodiment of the second set of embodiments: 1) the DL TCI states can be UE-specific while the UL TCI states can be shared across UEs; 2) the DL TCI states can be shared across UEs while the UL TCI states are UE-specific; 3) both the DL and UL TCI states are shared across UEs; and/or 4) both the DL and UL TCI states are UE-specific.

In one implementation of the first embodiment of the second set of embodiments, a sub-set of the UL TCI states configured by RRC is activated by an additional (e.g., PUSCH and/or PUCCH) TCI state activation and/or deactivation MAC CE that is different from (e.g., PDSCH and/or PDCCH) TCI state activation (or deactivation) MAC CE. In this implementation, the UL TCI and the DL TCI state indication are separately indicated via DCI to the UE with two TCI codepoints. In another implementation of the first embodiment of the second set of embodiments, a single TCI codepoint is used to indicate either UL or DL TCI states, where some indices point to UL TCI states and other indices point to DL TCI states. In some implementations of the first embodiment of the second set of embodiments, the TCI codepoint for DL TCI states is present in one DCI (e.g., DCI format 1_1, DCI format 1_2), while the TCI codepoint for UL TCI states is present in another DCU (e.g., DCI format 0_1, DCI format 0_2). In various implementations of the first embodiment of the second set of embodiments, both TCI codepoints can be present in one DCI. In some other implementations of the first embodiment of the second set of embodiments, only a TCI code point (e.g., either UL or DL) can be present in one DCI.

In a second embodiment of the second set of embodiments, a single MAC CE is used to indicate the activation and/or deactivation of UL and DL TCI states for PUSCH, PDSCH, PUCCH, and/or PDCCH. In this embodiment, one MAC CE activates ‘N’ TCI states for UL and ‘M’ TCI states for DL. In one implementation of the second embodiment of the second set of embodiments, the activated TCI states will correspond to ‘N+M’ indices, where the first N indices are used to indicate UL TCI states while the second M indices are used to indicate DL TCI states, or vice-versa. In another implementation of the second embodiment of the second set of embodiments, the activated TCI states will correspond to max {N,M} indices, where each index can indicate UL and DL TCI states, only UL TCI states, or only DL TCI states. In some implementations of the second embodiment of the second set of embodiments, if only one TCI state is indicated, even if both UL and DL TCI states are configured, then the UE is expected to apply the indicated TCI state for DL. In alternate implementations of the second embodiment of the second set of embodiments, if only one TCI state is indicated, even if both UL and DL TCI states are configured, then the UE is expected to apply the indicated TCI state for UL. In some implementations of the second embodiment of the second set of embodiments, depending upon the DCI format, the only indicated TCI state can be either UL or DL. For example, DCI format 0_1 and/or DCI format 0_2 may indicate UL, while DCI format 1_1 and/or DCI format 1_2 may indicate DL.

In a third embodiment of the second set of embodiments, a UE can be configured by RRC with the following pools of TCI states (e.g., with at least one pool for joint TCI states): 1) joint TCI states for UL and DL; 2) joint TCI states for UL and DL with separate UL TCI states; 3) joint TCI states for UL and DL with separate DL TCI states; and/or 4) joint TCI states for UL and DL with separate UL TCI states and separate DL TCI states.

In one implementation of the third embodiment of the second set of embodiments, if the UE is configured with only single pool of joint TCI states for UL and DL, then a single MAC CE can be used to activate a sub-set of TCI states, where the index of the activated TCI state can indicate a DL and UL TCI state based on a common RS. In some implementations of the third embodiment of the second set of embodiments, if the DL TCI states are not allowed to be configured with certain RS types, and if the joint TCI indicates such a TCI state, then the TCI state is expected to be allowed only for DL or vice-versa.

In some embodiments, if a joint TCI state is configured and indicated to the UE, then the joint TCI state is only applicable to PDSCH and PUSCH. In various embodiments, indicated joint TCI states are applicable to PDSCH, PUSCH, and PUCCH. In certain embodiments, an indicated joint TCI state is applicable to PDSCH, PDCCH, PUSCH, and PUCCH. In some embodiments, an indicated joint TCI state is applicable to PDSCH, PUSCH, and PUCCH. In one implementation, the indication to the UE on which channels the joint TCI state applies to can be based on MAC CE activation, where different MAC CE can be configured, but only one can be used to activate the joint TCI state. Based on which MAC CE is used, the UE determines the applicable channels for joint TCI states. In another implementation, RRC configuration is used to indicate which are the applicable channels for joint TCI states. For example, a CORESET configuration can be enhanced to indicate which are the applicable channels. In such case, one possibility is to have multiple values possible for parameters such as tci-PresentInDCL. Depending up on which value is configured, the UE can determine which are the applicable channels. In some implementations, DCI dynamically indicates the applicable channels along with a TCI state. It should be noted that similar embodiments and/or implementations can be applied to determine applicable channels for separate UL and DL TCI states.

In various embodiments, only a single pool of TCI states that can be either a joint TCI states pool, UL TCI states pool, or DL TCI states pool. In one implementation, a different MAC CE can be used to activate the sub-set of TCI states from the configured pool. For example, an UL MAC CE, if used to activate the TCI states, imply that the activated TCI states are only for UL transmissions. Similarly, if a DL MAC CE is used to activate TCI states, then it implies the activated TCI states are only for DL transmissions. Moreover, if a joint MAC CE is used to activate TCI states, then it implies the activated TCI states are for both UL and DL transmissions. In alternate implementation, only a single MAC CE is used to activate the sub-set of TCI states from the configured pool. Then the UE is indicated by RRC signaling if the activate TCI states are UL, DL, or joint. For example, the CORESET configuration can be used to indicate such information by parameters such as tci-PresentInDCI. Depending on which value is configured, the UE can determine whether it is an UL, a DL, or joint TCI state. In some implementation, DCI dynamically indicates an applicable TCI mode (e.g., UL, DL or joint) along with the indicated TCI state.

It should be noted that embodiments and/or implementations found herein may be applied to: 1) SPS PDSCH; 2) CG PUSCH; and/or 3) other DL and/or UL signals such as CSI-RS, SSB, SRS, PT-RS.

In a third set of embodiments, there may be beam failure detection and recovery with both UE-specific beams and shared UE beams. According to the third set of embodiments, a UE can be configured, activate, and/or indicated with both UE-specific TCI states and shared TCI states. In the third set of embodiments, the UE is expected to use only one of either UE-specific TCI or shared TCI. If beam failure in the physical (“PHY”) layer is detected with the first indicated TCI state (e.g., first among UE-specific or shared TCI), instead of indicating the beam failure indicator (“BFI”) to the MAC, the UE switches to a second indicated TCI state. If the UE is able to transmit and/or receive with the second indicated TCI state, then this beam can be used to follow beam recovery for the first indicated TCI state type. However, if beam failure is detected even with the second indicated TCI state, then the BFI instance is reported from PHY to MAC.

In one implementation of the third set of embodiments, the UE is indicated with a shared TCI state (or shared beam) as a first TCI state and a UE-specific TCI state (or UE-specific beam) as a second TCI state, then the UE uses the first TCI state for transmission and/or reception. If beam failure is detected in PHY with the shared UE beam, then the UE falls back to the UE-specific beam before indicating BFI to the MAC. A beam failure detection (“BFD”) RS may be configured separately for a shared TCI and a UE specific TCI state.

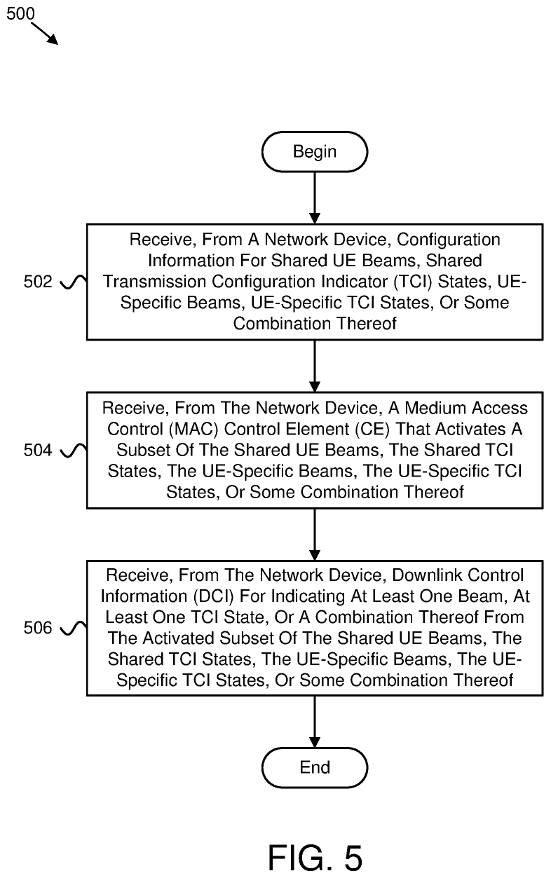

FIG. 5 is a flow chart diagram illustrating one embodiment of a method 500 for configuring shared and UE specific beams and TCI states. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a user equipment (UE) from a network device, configuration information for shared UE beams, shared transmission configuration indicator (TCI) states, UE-specific beams, UE-specific TCI states, or some combination thereof. In some embodiments, the method 500 includes receiving 504, from the network device, a medium access control (MAC) control element (CE) that activates a subset of the shared UE beams, the shared TCI states, the UE-specific beams, the UE-specific TCI states, or some combination thereof. In certain embodiments, the method 500 includes receiving 506, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the method 500 further comprises receiving, from the network device, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof. In some embodiments, the method 500 further comprises receiving, from the network device, a first MAC CE command that activates a first subset of the first set, and as second MAC CE command that activates a second subset of the second set. In various embodiments, the method 500 further comprises receiving, from the network device, a first indication of a first TCI state from the first subset, and a second indication of a second TCI state from the second subset.

In one embodiment, the method 500 further comprises receiving, from the network device, one MAC CE command that activates either a first subset of the first set or a second subset of the second set. In certain embodiments, the method 500 further comprises receiving, from the network device, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof. In some embodiments, the method 500 further comprises receiving, from the network device, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only. In one embodiment, the first set of channels is UL only and the second set of channels is DL only.

In certain embodiments, the first set of channels comprises only control channels and the second set of channels comprises only data channels. In some embodiments, the first set of channels comprises only data channels and the second set of channels comprises only control channels.

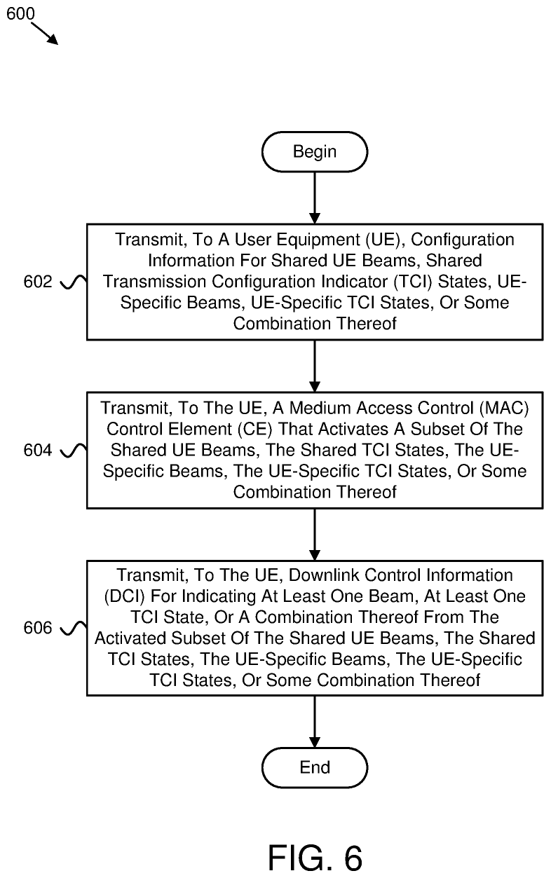

FIG. 6 is a flow chart diagram illustrating another embodiment of a method 600 for configuring shared and UE specific beams and TCI states. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a network device to a user equipment (UE), configuration information for shared UE beams, shared transmission configuration indicator (TCI) states, UE-specific beams, UE-specific TCI states, or some combination thereof. In some embodiments, the method 600 includes transmitting 604, to the UE, a medium access control (MAC) control element (CE) that activates a subset of the shared UE beams, the shared TCI states, the UE-specific beams, the UE-specific TCI states, or some combination thereof. In certain embodiments, the method 600 includes transmitting 606, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the method 600 further comprises transmitting, to the UE, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof. In some embodiments, the method 600 further comprises transmitting, to the UE, a first MAC CE command that activates a first subset of the first set, and as second MAC CE command that activates a second subset of the second set. In various embodiments, the method 600 further comprises transmitting, to the UE, a first indication of a first TCI state from the first subset, and a second indication of a second TCI state from the second subset.

In one embodiment, the method 600 further comprises transmitting, to the UE, one MAC CE command from that activates either a first subset of the first set or a second subset of the second set. In certain embodiments, the method 600 further comprises transmitting, to the UE, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof. In some embodiments, the method 600 further comprises transmitting, to the UE, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only. In one embodiment, the first set of channels is UL only and the second set of channels is DL only.

In certain embodiments, the first set of channels comprises only control channels and the second set of channels comprises only data channels. In some embodiments, the first set of channels comprises only data channels and the second set of channels comprises only control channels.

In one embodiment, an apparatus comprises a user equipment (UE). the apparatus further comprises: a receiver that: receives, from a network device, configuration information for shared UE beams, shared transmission configuration indicator (TCI) states, UE-specific beams, UE-specific TCI states, or some combination thereof; receives, from the network device, a medium access control (MAC) control element (CE) that activates a subset of the shared UE beams, the shared TCI states, the UE-specific beams, the UE-specific TCI states, or some combination thereof; and receives, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the receiver receives, from the network device, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

In some embodiments, the receiver receives, from the network device, a first MAC CE command that activates a first subset of the first set, and as second MAC CE command that activates a second subset of the second set.

In various embodiments, the receiver receives, from the network device, a first indication of a first TCI state from the first subset, and a second indication of a second TCI state from the second subset.

In one embodiment, the receiver receives, from the network device, one MAC CE command that activates either a first subset of the first set or a second subset of the second set.

In certain embodiments, the receiver receives, from the network device, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof.

In some embodiments, the receiver receives, from the network device, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only.

In one embodiment, the first set of channels is UL only and the second set of channels is DL only.

In certain embodiments, the first set of channels comprises only control channels and the second set of channels comprises only data channels.

In some embodiments, the first set of channels comprises only data channels and the second set of channels comprises only control channels.

In one embodiment, a method at a user equipment (UE) comprises: receiving, from a network device, configuration information for shared UE beams, shared transmission configuration indicator (TCI) states, UE-specific beams, UE-specific TCI states, or some combination thereof; receiving, from the network device, a medium access control (MAC) control element (CE) that activates a subset of the shared UE beams, the shared TCI states, the UE-specific beams, the UE-specific TCI states, or some combination thereof; and receiving, from the network device, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the method further comprises receiving, from the network device, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

In some embodiments, the method further comprises receiving, from the network device, a first MAC CE command that activates a first subset of the first set, and as second MAC CE command that activates a second subset of the second set.

In various embodiments, the method further comprises receiving, from the network device, a first indication of a first TCI state from the first subset, and a second indication of a second TCI state from the second subset.

In one embodiment, the method further comprises receiving, from the network device, one MAC CE command that activates either a first subset of the first set or a second subset of the second set.

In certain embodiments, the method further comprises receiving, from the network device, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof.

In some embodiments, the method further comprises receiving, from the network device, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only.

In one embodiment, the first set of channels is UL only and the second set of channels is DL only.

In certain embodiments, the first set of channels comprises only control channels and the second set of channels comprises only data channels.

In some embodiments, the first set of channels comprises only data channels and the second set of channels comprises only control channels.

In one embodiment, an apparatus comprises a network device. The apparatus further comprises: a transmitter that: transmits, to a user equipment (UE), configuration information for shared UE beams, shared transmission configuration indicator (TCI) states, UE-specific beams, UE-specific TCI states, or some combination thereof; transmits, to the UE, a medium access control (MAC) control element (CE) that activates a subset of the shared UE beams, the shared TCI states, the UE-specific beams, the UE-specific TCI states, or some combination thereof; and transmits, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the transmitter transmits, to the UE, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

In some embodiments, the transmitter transmits, to the UE, a first MAC CE command that activates a first subset of the first set, and as second MAC CE command that activates a second subset of the second set.

In various embodiments, the transmitter transmits, to the UE, a first indication of a first TCI state from the first subset, and a second indication of a second TCI state from the second subset.

In one embodiment, the transmitter transmits, to the UE, one MAC CE command from that activates either a first subset of the first set or a second subset of the second set.

In certain embodiments, the transmitter transmits, to the UE, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof.

In some embodiments, the transmitter transmits, to the UE, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only.

In one embodiment, the first set of channels is UL only and the second set of channels is DL only.

In certain embodiments, the first set of channels comprises only control channels and the second set of channels comprises only data channels.

In some embodiments, the first set of channels comprises only data channels and the second set of channels comprises only control channels.

In one embodiment, a method at a network device comprises: transmitting, to a user equipment (UE), configuration information for shared UE beams, shared transmission configuration indicator (TCI) states, UE-specific beams, UE-specific TCI states, or some combination thereof, transmitting, to the UE, a medium access control (MAC) control element (CE) that activates a subset of the shared UE beams, the shared TCI states, the UE-specific beams, the UE-specific TCI states, or some combination thereof, and transmitting, to the UE, downlink control information (DCI) for indicating at least one beam, at least one TCI state, or a combination thereof from the activated subset of the shared UE beams, the shared TCI states, the UE-specific beams, the UE-specific TCI states, or some combination thereof.

In certain embodiments, the method further comprises transmitting, to the UE, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

In some embodiments, the method further comprises transmitting, to the UE, a first MAC CE command that activates a first subset of the first set, and as second MAC CE command that activates a second subset of the second set.

In various embodiments, the method further comprises transmitting, to the UE, a first indication of a first TCI state from the first subset, and a second indication of a second TCI state from the second subset.

In one embodiment, the method further comprises transmitting, to the UE, one MAC CE command from that activates either a first subset of the first set or a second subset of the second set.

In certain embodiments, the method further comprises transmitting, to the UE, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof.

In some embodiments, the method further comprises transmitting, to the UE, an indication to use the shared UE beams, the shared TCI states, or a combination thereof for a first set of channels and to use the UE-specific beams, the UE-specific TCI states, or a combination thereof for a second set of channels.

In various embodiments, the first set of channels is downlink (DL) only and the second set of channels is uplink (UL) only.

In one embodiment, the first set of channels is UL only and the second set of channels is DL only.

In certain embodiments, the first set of channels comprises only control channels and the second set of channels comprises only data channels.

In some embodiments, the first set of channels comprises only data channels and the second set of channels comprises only control channels.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive, from a network device, configuration information for shared UE beams, shared transmission configuration indicator (TCI) states, UE-specific beams, UE-specific TCI states, or a combination thereof,
receive, from the network device, a medium access control (MAC) control element (CE) that activates a subset of the shared UE beams, the shared TCI states, the UE-specific beams, the UE-specific TCI states, or a combination thereof; and
receive, from the network device, downlink control information (DCI) for indicating at least one beam, at least one TCI state, or a combination thereof from the activated subset of the shared UE beams, the shared TCI states, the UE-specific beams, the UE-specific TCI states, or a combination thereof.

2. The UE of claim 1, wherein the at least one processor is configured to cause the UE to receive, from the network device, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

3. The UE of claim 2, wherein the at least one processor is configured to cause the UE to receive, from the network device, a first MAC CE command that activates a first subset of the first set, and as second MAC CE command that activates a second subset of the second set.

4. The UE of claim 3, wherein the at least one processor is configured to cause the UE to receive, from the network device, a first indication of a first TCI state from the first subset, and a second indication of a second TCI state from the second subset.

5. The UE of claim 2, wherein the at least one processor is configured to cause the UE to receive, from the network device, one MAC CE command that activates either a first subset of the first set or a second subset of the second set.

6. The UE of claim 1, wherein the at least one processor is configured to cause the UE to receive, from the network device, an indication to use the shared UE beams, the shared TCI states, or a combination thereof, and, in response to a beam failure detection on the shared UE beams, the shared TCI states, or the combination thereof, switching to the UE-specific beams, the UE-specific TCI states, or a combination thereof.

7. The UE of claim 1, wherein the at least one processor is configured to cause the UE to receive, from the network device, an indication to use the shared UE beams, the shared TCI states, or a combination thereof for a first set of channels and to use the UE-specific beams, the UE-specific TCI states, or a combination thereof for a second set of channels.

8. The UE of claim 7, wherein the first set of channels is downlink (DL) only and the second set of channels is uplink (UL) only.

9. The UE of claim 7, wherein the first set of channels is uplink (UL) only and the second set of channels is DL only.

10. The UE of claim 7, wherein the first set of channels comprises only control channels and the second set of channels comprises only data channels.

11. The UE of claim 7, wherein the first set of channels comprises only data channels and the second set of channels comprises only control channels.

12. A processor for wireless communication, comprising:
at least one controller coupled with at least one memory and configured to cause the processor to:
receive, from a network device, configuration information for shared user equipment (UE) beams, shared transmission configuration indicator (TCI) states, UE-specific beams, UE-specific TCI states, or a combination thereof;
receive, from the network device, a medium access control (MAC) control element (CE) that activates a subset of the shared UE beams, the shared TCI states, the UE-specific beams, the UE-specific TCI states, or some a combination thereof; and
receive, from the network device, downlink control information (DCI) for indicating at least one beam, at least one TCI state, or a combination thereof from the activated subset of the shared UE beams, the shared TCI states, the UE-specific beams, the UE-specific TCI states, or a combination thereof.

13. An apparatus for performing a network function, the apparatus comprising:
at least one memory; and
at least one processor coupled with the at least one memory and configured to cause the apparatus to:
transmit, to a user equipment (UE), configuration information for shared UE beams, shared transmission configuration indicator (TCI) states, UE-specific beams, UE-specific TCI states, or a combination thereof;
transmit, to the UE, a medium access control (MAC) control element (CE) that activates a subset of the shared UE beams, the shared TCI states, the UE-specific beams, the UE-specific TCI states, or a combination thereof; and
transmit, to the UE, downlink control information (DCI) for indicating at least one beam, at least one TCI state, or a combination thereof from the activated subset of the shared UE beams, the shared TCI states, the UE-specific beams, the UE-specific TCI states, or a combination thereof.

14. The of claim 13, wherein the at least one processor is configured to cause the apparatus to transmit, to the UE, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

15. The of claim 14, wherein the at least one processor is configured to cause the apparatus to transmit, to the UE, a first MAC CE command that activates a first subset of the first set, and as second MAC CE command that activates a second subset of the second set.

16. A method performed by a user equipment (UE), the method comprising:
receiving, from a network device, configuration information for shared user equipment (UE) beams, shared transmission configuration indicator (TCI) states, UE-specific beams, UE-specific TCI states, or a combination thereof;
receiving, from the network device, a medium access control (MAC) control element (CE) that activates a subset of the shared UE beams, the shared TCI states, the UE-specific beams, the UE-specific TCI states, or a combination thereof; and
receiving, from the network device, downlink control information (DCI) for indicating at least one beam, at least one TCI state, or a combination thereof from the activated subset of the shared UE beams, the shared TCI states, the UE-specific beams, the UE-specific TCI states, or a combination thereof.

17. The processor of claim 12, wherein the at least one controller is configured to cause the processor to receive, from the network device, first radio resource control (RRC) configuration information that configures a first set comprising the shared UE beams, the shared TCI states, or a combination thereof, and second RRC configuration information that configures a second set comprising the UE-specific beams, the UE-specific TCI states, or a combination thereof.

18. The processor of claim 17, wherein the at least one controller is configured to cause the processor to receive, from the network device, a first MAC CE command that activates a first subset of the first set, and as second MAC CE command that activates a second subset of the second set.

19. The processor of claim 18, wherein the at least one controller is configured to cause the processor to receive, from the network device, a first indication of a first TCI state from the first subset, and a second indication of a second TCI state from the second subset.

20. The processor of claim 17, wherein the at least one controller is configured to cause the processor to receive, from the network device, one MAC CE command that activates either a first subset of the first set or a second subset of the second set.
